(19) United States
(12) Patent Application Publication
(10) Pub. No.: US 2026/0194618 A1
(43) Pub. Date: Jul. 9, 2026

(54) DIAGONALIZED SPATIAL SMOOTHING COHERENT DOA ESTIMATION METHOD BASED ON NON-CIRCULAR SIGNALS

(71) Applicant: Hangzhou Dianzi University, Hangzhou (CN)

(72) Inventors: Xudong Dong, Hangzhou (CN); Jun Zhao, Hangzhou (CN); Yufei Zhao, Hangzhou (CN); Xu Yang, Hangzhou (CN); Cheng Wang, Hangzhou (CN); Meng Sun, Hangzhou (CN); Xiaofei Zhang, Hangzhou (CN); Haibing Yin, Hangzhou (CN); Chenggang Yan, Hangzhou (CN)

(21) Appl. No.: 19/556,181

(22) Filed: Mar. 4, 2026

(30) Foreign Application Priority Data
Mar. 21, 2025 (CN) 202510339405.6

(51) Int. Cl. G01S 5/12; G01S 3/14; G01S 7/41

(52) U.S. Cl. CPC G01S 5/12; G01S 3/143; G01S 7/41

(57) ABSTRACT

A diagonalized spatial smoothing coherent DOA estimation method based on non-circular signals includes the following steps: firstly, receiving non-circular signals through a uniform linear array antenna to obtain received information; according to non-circular characteristics of the signals, concatenating the received information and the conjugate to form extended received information, and calculating the covariance matrix; then extracting subarrays from the covariance matrix diagonally, and performing augmented spatial smoothing operation on the extracted subarrays; splicing the results of smoothing operations to generate a new covariance matrix, and performing eigenvalue decomposition on the new covariance matrix to obtain a noise subspace; finally, based on the noise subspace, estimating the DOA of the non-circular signal by the reduced-dimension MUSIC algorithm.

### CROSS-REFERENCE TO RELATED APPLICATIONS

This application claims priority to Chinese Patent Application No. 202510339405.6, filed on Mar. 21, 2025, the contents of which are hereby incorporated by reference.

### TECHNICAL FIELD

The disclosure belongs to the technical fields of direction of arrival (DOA) estimation of coherent signals, radar and sonar positioning, and particularly relates to a diagonalized spatial smoothing coherent DOA estimation method based on non-circular signals.

### BACKGROUND

DOA estimation is the basis of array signal processing, which has great value in acoustics, speech, radar, sonar, circuit and wireless communication. Traditional subspace-based super-resolution DOA estimation techniques face a significant challenge in practical signal transmission scenarios, because signal reflection and refraction, multipath propagation leads to signal coherence. When array sensors receive coherent signals from different directions, the rank loss in the covariance matrix masks the key signal information, which makes the traditional subspace-based method ineffective.

In order to solve this problem, it is very important to restore the rank of the covariance matrix to match the number of sources. Common techniques for decoherence include dimensionality and nondimensional reduction processing methods, such as subspace-based method, norm-based method and spatial smoothing (SS) technique. Among them, the SS technology is particularly prominent, which uses overlapping subarrays and averages the covariance matrices to restore the rank. The typical SS technologies are forward and backward spatial smoothing methods, spatial smoothing processing (SSP), augmented spatial smoothing preprocessing, signal space-based ESS (ESS-SS), simplified spatial smoothing (SSS) and augmented spatial smoothing (ASS). Although the methods are effective, the algorithms need to lose the effective aperture of the array, thus reducing the number of signal estimates.

In recent years, several DOA estimation methods have improved the effective aperture through nonlinear arrays such as coprime arrays, but the performance is not good in computational complexity and estimation performance. Later, some scholars introduced non-circular phase into the DOA estimation, and on this basis, researchers have focused their attention on coherent signal estimation based on the non-circular phase. Although there are some DOA estimation methods based on forward smoothing, the computational complexity and estimation performance are not excellent.

### SUMMARY

Objective of the disclosure: in order to solve the problems existing in the prior art, the disclosure provides a diagonalized spatial smoothing coherent DOA estimation method based on non-circular signals.

Technical scheme: the disclosure provides a diagonalized spatial smoothing coherent DOA estimation method based on non-circular signals, including the following steps:
S1, receiving the non-circular signals through a uniform linear array antenna to obtain received information z(t);
S2, concatenating the received information z(t) and conjugate z*(t) into extended received information y(t) according to non-circular characteristics of signals, and calculating a covariance matrix R_{NC} of y(t);
S3, extracting subarrays R and R* from R_{NC} diagonally, and performing augmented spatial smoothing operation on extracted subarrays R and R* respectively to obtain R_{ASS} and

$${R}_{ASS}^{*} ;$$

S4, splicing R_{ASS} and

$${R}_{ASS}^{*}$$

to generate a new covariance matrix R_{NC-ASS}, and performing eigenvalue decomposition on a generated R_{NC-ASS} to obtain a noise subspace U_{N};
S5, based on the noise subspace U_{N}, estimating the DOA of the non-circular signals by a reduced-dimension MUSIC algorithm.

The disclosure has the following beneficial effects.

Compared with the prior art, the technical scheme adopted by the disclosure has the following technical effects: the non-circular phase is introduced, non-circular phase information is utilized, and the covariance matrix containing more information is not only generated by the method, but also the aperture is increased through virtual expansion, and noise interference is reduced. In addition, the method seamlessly integrates the ASS smoothing technology, and effectively recovers the rank of the covariance matrix containing non-circular phase, thus improving the robustness and accuracy of the DOA estimation.

### BRIEF DESCRIPTION OF THE DRAWINGS

FIG. 1 is a schematic diagram of a linear array structure according to the present disclosure.

FIG. 2 is a schematic diagram of the submatrix extraction process of the present disclosure.

FIG. 3A is a schematic diagram of the reduced-dimension MUSIC spatial spectrum of the subarray cross correlation method.

FIG. 3B is a schematic diagram of the reduced-dimension MUSIC spatial spectrum of the improved spatial smoothing method.

FIG. 3C is a schematic diagram of the reduced-dimension MUSIC spatial spectrum of the augmented spatial smoothing method.

FIG. 3D is a schematic diagram of the reduced-dimension MUSIC spatial spectrum of the method of the present disclosure.

FIG. 4 is a schematic diagram of RMSE under different snapshot numbers using reduced-dimension MUSIC in the present disclosure.

FIG. 5 is an RMSE schematic diagram of the disclosure using reduced-dimension MUSIC at different signal-to-noise ratios.

FIG. 6 is a schematic diagram of RMSE under different numbers of array elements M using reduced-dimension MUSIC in the present disclosure.

### DETAILED DESCRIPTION OF THE EMBODIMENTS

The accompanying drawings, which constitute a part of the disclosure, are used to provide a further understanding of the disclosure, and the illustrative embodiments of the disclosure and their descriptions are used to explain the disclosure, and do not constitute an undue limitation of the disclosure.

This embodiment provides a diagonalized spatial smoothing coherent DOA estimation method based on non-circular signals based on the following principles. The specific method of this embodiment is as follows:

Step 1: data model of signals under uniform linear array.

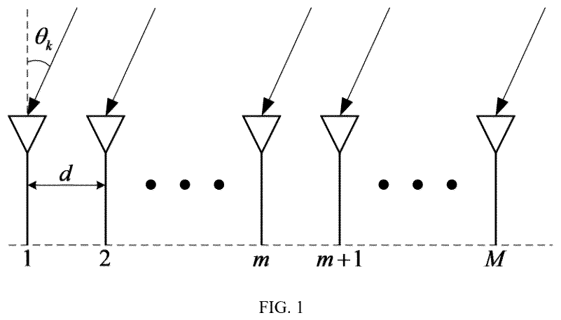

FIG. 1 shows a uniform linear array including sensors, where a uniform linear array including M sensors, where an array spacing d=λ/2, λ is a signal carrier wavelength, assuming that K narrow-band far-field non-circular coherent signals sₖ(t) are incident on the array at an incident angle θₖ (k=1, 2, . . . , K), for an m-th sensor of the array (taking the first sensor as the reference point), data z(t) received at time t of the array is expressed as:

$${z}_{m} ( t ) = {\sum }_{k = 1}^{K} {a}_{m} ( {θ}_{k} ) {s}_{k} ( t ) + {n}_{m} ( t ) ;$$

where

$${a}_{m} ( {θ}_{k} ) = {e}^{- j 2 π \frac{d}{λ} ( m - 1 ) sin {θ}_{k}}$$

is a direction vector, corresponding to an array response of the signals sₖ(t) being incident from an angle θₖ, and nₘ(t) is additive white Gaussian noise, indicating the influence of noise on the received signals.
all the sensors in the array are combined into a column vector z(t), expressed as z(t)=As(t)+n(t),
where signal vector s(t)=[s₁(t), s₂(t), . . . , s_{K}(t)]^{T}, noise vector

$$n ( t ) \sim CN ( \cdot \vert 0 , {σ}_{n}^{2} {\text{?}}_{M} )$$

obeys Gaussian distribution,

$${σ}_{n}^{2}$$

is noise power, [symbol] _{M} is M×M order identity matrix; A=[a(θ₁), a(θ₂), . . . , a(θ_{K})] is a steering matrix of M×K, where

$$a ( {θ}_{k} ) = {[ 1 , {e}^{- j π sin {θ}_{k}} , {e}^{- j 2 π sin {θ}_{k}} , … , {e}^{- j ( M - 1 ) π sin {θ}_{k}} ]}^{T}$$

is a steering vector of the angle θₖ;
for strictly non-circular signals (such as binary phase shift keying and amplitude modulation signals), a received signal s(t) is expressed as s(t)=Φs₀(t), where Φ=diag{e^{-jφ}^{₁}, . . . , e^{-jφ}^{_{K}}} is a diagonal matrix, φₖ is a non-circular phase of a k-th signal, and a real signal vector s₀(t)=[s₀₁ (t), . . . , s₀ₖ(t), . . . , s_{0K}(t)]^{T}.

Therefore, the array received information of the non-circular signals is obtained:

$$z ( t ) = As ( t ) + n ( t ) = A Φ {s}_{0} ( t ) + n ( t )$$

Step 2: the received information z(t) is concatenated with the conjugate z*(t) to obtain a concatenated extended received information y(t),

$$y ( t ) = [ \begin{matrix}z ( t ) \\ {z}^{*} ( t )\end{matrix} ] = [ \begin{matrix}A Φ \\ {A}^{*} {Φ}^{*}\end{matrix} ] {s}_{0} ( t ) + [ \begin{matrix}n ( t ) \\ {n}^{*} ( t )\end{matrix} ] ;$$

where [ ]* represents conjugate operation, and a data covariance matrix of y(t) is:

$${R}_{NC} = E [ y ( t ) {y}^{H} ( t ) ] = [ \begin{matrix}R & {R}^{′} \\ {R}^{r *} & {R}^{*}\end{matrix} ] ;$$

where R□E[y(t)y^{H}(t)]= is a covariance matrix of output, R*□E[y(t)y^{T}(t)]= is an elliptical covariance matrix, [ ]^{T} is a transposition operation, and [ ]^{H} is a conjugate transposition operation.

The information of the covariance matrix of the array output signals constructed by the above formula includes non-circular coherent signals, and the existing decoherence algorithms cannot make use of the characteristics of non-circular signals. Therefore, it is considered to extract R and R* from R_{NC} according to the structure. Next, the covariance matrix R and elliptical covariance matrix R* output from the array will be decohered by using the decoherence method.

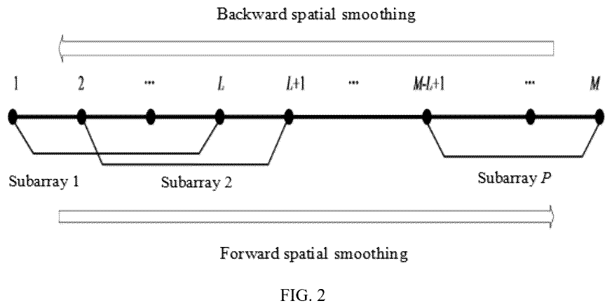

Step 3: obviously, R at this time may be considered as the data covariance of signals without circular phase received by M sensing linear antenna arrays. For smoothing operation, the schematic diagram of the front and back smoothing structure is shown in FIG. 2. At this time, it is assumed that M sensors are divided into P overlapping subarrays, each subarray has L elements, satisfying:

$$M = L + P - 1 ,$$

where P is a number of the overlapping subarrays, L is a number of the sensors in each subarray, and an index t is omitted, then:

$${z}_{i} = {A}_{1} {D}^{i - 1} s + {n}_{i} ,$$

where the noise vector of an i-th subarray is nᵢ. A₁=[a_{L}(θ₁), a_{L}(θ₂), . . . , a_{L} (θ_{K})] is the steering matrix corresponding to the first L element of the array, s is the signal vector, Dⁱ⁻¹ is the i−1 power of the diagonal matrix D, D=diag[e^{-jπ sin θ}^{₁}, . . . , e^{-jπ sin θ}^{_{K}}], and the size is K×K. Therefore, the cross covariance matrix R_{i,j} of the i-th subarray and the j-th subarray may be expressed as:

$${R}_{i , j} = E [ {z}_{i} {z}_{j}^{H} ] = {A}_{1} {D}^{i - 1} {{R}_{S} ( {D}^{j - 1} )}^{H} {A}_{1}^{H} + {σ}_{n}^{2} {I}_{L} ;$$

I_{L} is an identity matrix with dimension L×L,

$${σ}_{n}^{2}$$

is noise variance, E[ ] is the expected operation, and R_{S}=E[s(t)s^{H}(t)] is a signal covariance matrix; similarly, a backward cross covariance matrix R̅_{i,j} of the i-th subarray and the j-th subarray is:

$${\overline{R}}_{i , j} = {J [ E [ {z}_{i} {z}_{j}^{H} ] ]}^{*} J = J {R}_{i , j}^{*} J ,$$

where J is an L×L antisymmetric identity matrix.

Because the received signals are fully coherent, the rank of the signal covariance matrix R_{S} is 1, so all the information of the received signals is contained in the maximum eigenvalue and the corresponding eigenvector. Accordingly, the signal subspace matrix Γ_{S} may be defined as:

$${Γ}_{S} = {τ}_{1} {u}_{1} {u}_{1}^{H} ;$$

where τ₁ represents the largest eigenvalue of matrix R after eigenvalue decomposition, and the corresponding largest eigenvector is u₁. In this case, subspace-based methods, such as MUSIC and ESPRIT, may not be directly applied because the subspace-based methods operate on full rank matrices.
letting u₁=At then Γ_{S}=τ₁·At·t^{H}A^{H}, then obtaining:

$$A {R}_{S} {A}^{H} = {τ}_{1} {u}_{1} {u}_{1}^{H} + {σ}_{n}^{2} {\sum }_{i = 2}^{M} {u}_{i} {u}_{i}^{H} - {σ}_{n}^{2} {I}_{M} = {τ}_{1} {u}_{1} {u}_{1}^{H} - {σ}_{n}^{2} {u}_{1} {u}_{1}^{H} = ( {τ}_{1} - {σ}_{n}^{2} ) {u}_{1} {u}_{1}^{H} ;$$

therefore,

$$t = \frac{{R}_{S} {A}^{H} {u}_{1}}{{τ}_{1} - {σ}_{n}^{2}}$$

is a vector of K×1; letting μᵢ represent an i-th forward subarray and μᵢ=A₁Dⁱ⁻¹t, then a forward cross covariance matrix of the i-th subarray and the j-th subarray is:

$${Γ}_{i , j} = E [ {μ}_{i} {μ}_{j}^{H} ] [ = {A}_{1} {D}^{i - 1} t {{t}^{H} ( {D}^{j - 1} )}^{H} {A}_{1}^{H} ;$$

where

$$E [ {μ}_{i} {μ}_{j}^{H} ]$$

represents an (i: i+L−1, j: j+L−1) element of Γ_{S};
similarly, the backward cross covariance matrix of the i-th subarray and the j-th subarray is defined as:

$${\overline{Γ}}_{i , j} = {J ( E [ {μ}_{i} {μ}_{j}^{H} ] )}^{*} J = J {Γ}_{i , j}^{*} J ;$$

In order to reduce the computational load, an ASS smoothing matrix R_{ASS} is obtained by using an augmented spatial smoothing (ASS) method:

$${R}_{ASS} = \frac{1}{3 {P}^{2}} {\sum }_{i = 1}^{P} {\sum }_{j = 1}^{P} [ ( {Γ}_{i , j} + {Γ}_{j , i} + {Γ}_{j , j} ) + ( {\overline{Γ}}_{i , j} + {\overline{Γ}}_{j , i} + {\overline{Γ}}_{j , j} ) ] ;$$

a same operation is performed on the matrix R to obtain an ASS smoothing matrix

$${R}_{A S S}^{*} .$$

Step 4: according to the previous extraction method of R and R*, R_{ASS} and

$${R}_{A S S}^{*}$$

are spliced diagonally to obtain R_{NC-ASS}; at this time, R_{NC-ASS} is a covariance matrix after ASS smoothing:

$${R}_{N C - ASS} = [ \begin{matrix}{R}_{A S S} & 0 \\ 0 & {R}_{A S S}^{*}\end{matrix} ] ;$$

next, the eigenvalue decomposition is performed on R_{NC-ASS}:

$${R}_{N C - A S S} = {U}_{S} {Λ}_{S} {U}_{S}^{H} + {U}_{N} {Λ}_{N} {U}_{N}^{H} ;$$

where eigenvectors corresponding to the first K eigenvalues form a signal subspaces U_{S}, and Λ_{S} is a diagonal matrix including the first K eigenvalues; the remaining eigenvectors form the noise subspace U_{N}, and Λ_{N} is a diagonal matrix including the remaining eigenvalues.

Step 5: the noise subspace U_{N} obtained by eigenvalue decomposition of R_{NC-ASS} is expanded by array. At this time, the elevation angle and non-circular phase of K signals are obtained by using MUSIC algorithm for binary search. Because of the introduction of the binary search, the computational complexity of two-dimensional MUSIC is very high, so it is necessary to use the reduced-dimension MUSIC algorithm to estimate the DOA of non-circular signals. This method only needs one-dimensional search, which greatly reduces the computational complexity. Then the corresponding steering vector also needs to be expanded according to the expanded characteristics of the array. The original steering vector is a(θₖ), and the expanded steering vector should be:

$$P ( {θ}_{k} ) = [ \begin{matrix}a ( {θ}_{k} ) & {0}_{M \times 1} \\ {0}_{M \times 1} & {a}^{*} ( {θ}_{k} )\end{matrix} ]$$

based on the noise subspace U_{N} and a corresponding steering vector P(θₖ) in the above Step 4, DOA is accurately estimated by using reduced-dimension MUSIC, and a spectral peak search function of the reduced-dimension MUSIC is:

$${f}_{R D - MUSIC} ( θ ) = \frac{1}{{e}^{H} [ {P ( θ )}^{H} {U}_{N} {U}_{N}^{H} P ( θ ) ] e} ;$$

where e=[1, 0]^{T}, a location of a spectral peak of the spectral peak search function is an estimated value of the DOA.

### Performance Analysis and Experimental Analysis

### 1. Complexity Analysis

The number of complex multiplications is used as the criterion of computational complexity. The complexity of the method mainly includes: the computational complexity O{4M²SNAP} required for calculating the sample covariance matrix R_{NC}, where SNAP represents the number of snapshots, the complexity of the ASS algorithm is O{L²P²}, the computational complexity of performing EVD on R_{NC-ASS} to find the noise subspace U_{N} is O{(2L)³}, and the computational complexity required for spectral function search is O{(5LK²+K²+K)n}, where n represents the number of searches. Combining all these components, the overall computational complexity of the proposed algorithm is:

$$O \{ 4 {M}^{2} SNAP + {L}^{2} {P}^{2} + 8 {L}^{3} + ( 5 L {K}^{2} + {K}^{2} + K ) n \} .$$

### 2. Experimental Analysis

In order to verify the effect of the above method, many simulation experiments are carried out in this embodiment, and the experimental performance is analyzed, as follows:

### (1) Experimental Performance Evaluation Index:

the main indicator used to quantify performance is root mean square error (RMSE), which is defined as follows:

$$RMSE = \sqrt{\frac{1}{K \cdot MC} {{\sum }^{K}}_{k = 1} {\sum }_{j = 1}^{MC} {( {\hat{θ}}_{ky} - {θ}_{k} )}^{2}} ;$$

where \hat{θ}ₖⱼ is the accurate estimated value of DOA of the k-th source in the j-th Monte Carlo process, K indicates the number of sources, MC indicates the number of Monte Carlo experiments, and \hat{θ}ₖ is the true DOA of the k-th source.

In the next simulation, the carrier frequency of the signal f₀=10⁶, the speed of light C=3×10⁸ m/s, the arrival angle of the fully coherent signal is [−7°, 8°], and the circular phase is [20°,60°].

### 3. Experimental Renderings

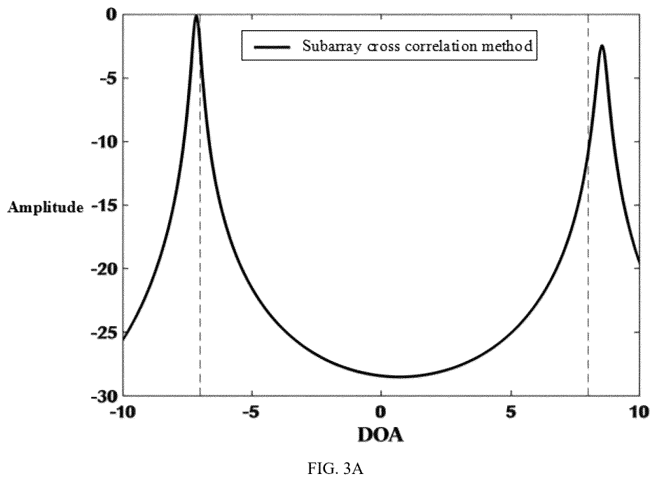

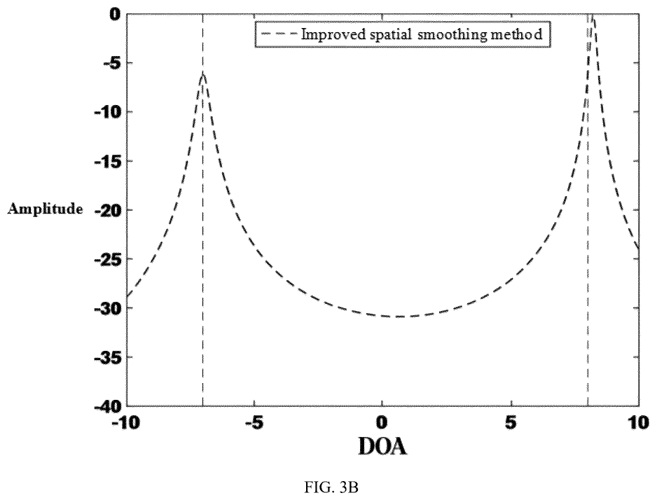

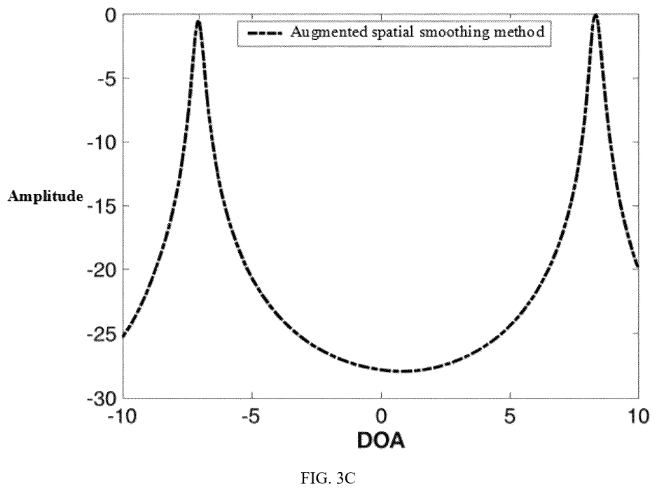

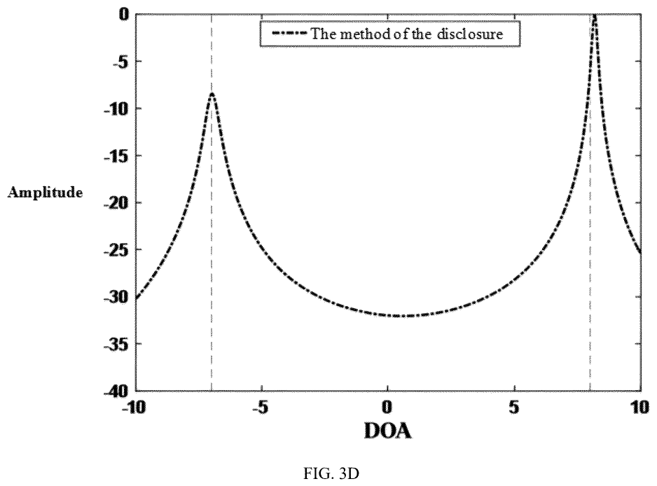

FIG. 3 shows the MUSIC spatial spectrum of the present disclosure under the conditions that the arrival angle of two adjacent coherent signals is [−7°, 8°], the circular phase is [20°,60°], the number of snapshots is 300, and the signal-to-noise ratio is 0 dB. In this experiment, the MUSIC spectrum estimated values of two coherent signals with incident angles [−7°,8°] and circular phase [20°,60°] are calculated. Obviously, the proposed method is capable of accurately identifying the spectral peaks of the two signals, and the effect is better than other methods.

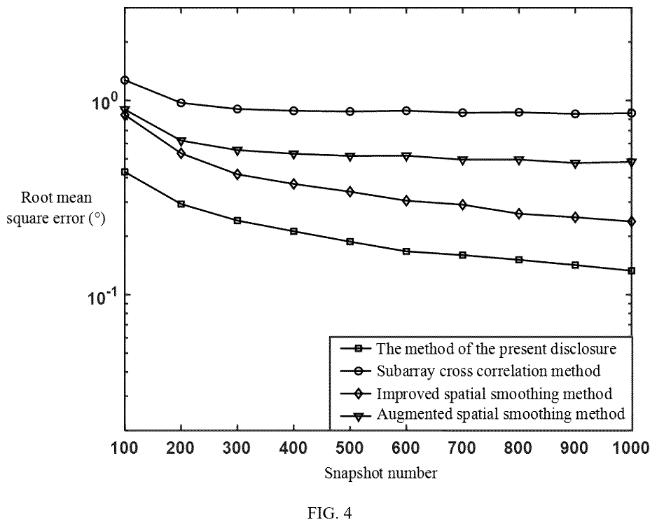

FIG. 4 is a diagram of the present invention when two adjacent coherent signals under the conditions that the arrival angle is [−7°,8°], the circular phase is [20°,60°], SNR=0 dB, the number of antennas M=10, and Monte Carlo MC=1000 times, the root mean square error (RMSE) image of the DOA angle is estimated by using reduced-dimension MUSIC under different snapshot numbers. The number of snapshots varies from 200 to 1000. Obviously, with the increase of the number of snapshots, the proposed algorithm shows significant performance improvement and has always been superior to other algorithms.

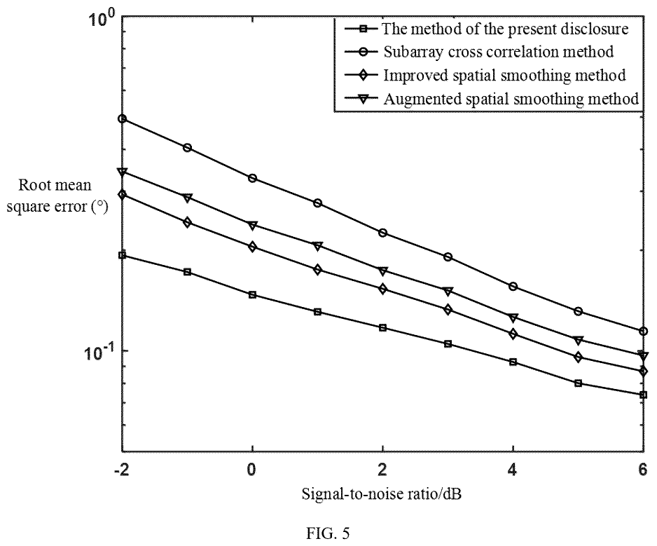

FIG. 5 is a root mean square error image of estimating the DOA angle by using reduced-dimension MUSIC under different signal-to-noise ratios under the condition that the arrival angle of two close coherent signals is [−7°,8°], the circular phase is [20°,60°], SNAP=300, M=10 and Monte Carlo MC=1000 times. The signal-to-noise ratio ranges from −2 dB to 6 dB. Obviously, the proposed algorithm shows a significant performance improvement, and it has always been superior to other algorithms.

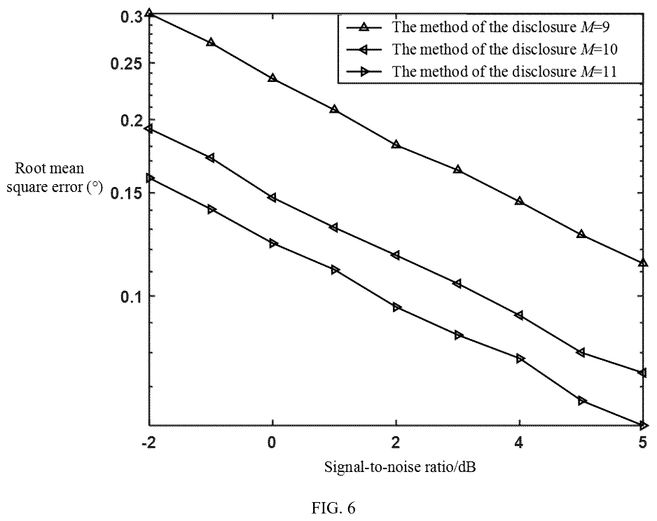

FIG. 6 is the signal-to-noise ratio-root mean square error image of the present disclosure under different antenna numbers. With SNR as the independent variable, the images of M=9, M=10 and M=11 are drawn respectively, and other simulation parameters are consistent with those of FIG. 5. As can be seen from the comparison of the figures, under the same signal-to-noise ratio, the performance under different antenna numbers is stable and superior to other algorithms, which shows that the algorithm of the present disclosure shows a high utilization rate for the number of array antennas, which is also consistent with the conclusion that the array aperture is improved by virtual expansion in theory.

To sum up, from the analysis of the simulation effect diagram, it can be seen that the diagonalized spatial smoothing coherent DOA estimation method based on non-circular signals proposed by the disclosure realizes the accurate DOA estimation of the non-circular phase coherent signals. This method not only generates a covariance matrix including more information, but also solves the DOA estimation problem of coherent signals effectively by smoothing, and increases the array aperture by virtual expansion. Compared with the conventional smoothing algorithm, the proposed method has a higher aperture utilization rate, and the estimation performance is better than that of the DOA method for estimating coherent signals by traditional smoothing technology.

The embodiments of the present disclosure have been described in detail with reference to the attached drawings, but the present disclosure is not limited to the above embodiments, and various changes may be made within the knowledge of those skilled in the art without departing from the purpose of the present disclosure.

What is claimed is:

1. A diagonalized spatial smoothing coherent DOA estimation method based on non-circular signals, comprising following steps:
S1, receiving the non-circular signals through a uniform linear array antenna to obtain received information z(t);
S2, concatenating the received information z(t) and conjugate z*(t) into extended received information y(t) according to non-circular characteristics of the signals, and calculating a covariance matrix R_{NC} of y(t);
S3, extracting subarrays R and R* from R_{NC} diagonally, and performing augmented spatial smoothing operation on extracted subarrays R and R* respectively to obtain R_{ASS} and
$${R}_{A S S}^{*} ;$$
S4, splicing R_{ASS} and
$${R}_{A S S}^{*}$$
to generate a new covariance matrix R_{NC-ASS}, and performing eigenvalue decomposition on a generated R_{NC-ASS} to obtain a noise subspace U_{N}:
S5, based on the noise subspace U_{N}, estimating the DOA of the non-circular signals by a reduced-dimension MUSIC algorithm.

2. The diagonalized spatial smoothing coherent DOA estimation method based on non-circular signals according to claim 1, wherein a specific process of obtaining the received information z(t) in step S1 is as follows:
a uniform linear array comprising M sensors, wherein an array spacing d=λ/2, λ is a signal carrier wavelength, assuming that K narrow-band far-field non-circular coherent signals sₖ(t) are incident on the array at an incident angle θₖ (k=1, 2, . . . , K) for an m-th sensor of the array, data z(t) received at time t is expressed as:
$${z}_{m} ( t ) = {\sum }_{k = 1}^{K} {a}_{m} ( {θ}_{k} ) {s}_{k} ( t ) + {n}_{m} ( t ) ;$$
wherein
$${a}_{m} ( {θ}_{k} ) = {e}^{- j 2 π \frac{d}{λ} ( m - 1 ) {sin θ}_{k}}$$
is a direction vector, corresponding to an array response of the signals sₖ(t) being incident from an angle θₖ, and nₘ(t) is additive white Gaussian noise;
all the sensors in the array are combined into a column vector z(t), expressed as z(t)=As(t)+n(t), signal vector s(t)=[s₁(t), s₂(t), . . . , s_{K}(t)]^{T}, noise vector
$$n ( t ) ∼ CN ( \cdot \vert 0 , {σ}_{n}^{2} {I}_{M} )$$
obeys Gaussian distribution,
$${σ}_{n}^{2}$$
is noise power, I_{M} is M×M order identity matrix; A=[a(θ₁), a(θ₂), . . . , a(θ_{K})] is a steering matrix of M×K, wherein
$$a ( {θ}_{k} ) = {[ 1 , {e}^{- j π sin {θ}_{k}} , {e}^{- f 2 {π sin θ}_{k}} , … , {e}^{- j ( M - 1 ) {π sin θ}_{k}} ]}^{T}$$
is a steering vector of the angle θₖ;
for strictly non-circular signals, a received signal s(t) is expressed as s(t)=Φs₀(t), wherein Φ=diag{e^{-jφ}^{₁}, . . . , e^{-jφ}^{_{K}}} is a diagonal matrix, φₖ is a non-circular phase of a k-th signal, and a real signal vector s₀(t)=[s₀₁ (t), . . . , s₀ₖ(t), . . . , s_{0K}(t)]^{T}, obtaining array received information of the non-circular signals:
$$z ( t ) = A s ( t ) + n ( t ) = A Φ {s}_{0} ( t ) + n ( t ) .$$

3. The diagonalized spatial smoothing coherent DOA estimation method based on non-circular signals according to claim 2, wherein a specific implementation process of step S2 is as follows:
concatenating the received information z(t) and the conjugate z*(t) to obtain a concatenated the extended received information y(t),
$$y ( t ) = [ \begin{matrix}z ( t ) \\ {z}^{*} ( t )\end{matrix} ] = [ \begin{matrix}A Φ \\ {A}^{*} {Φ}^{*}\end{matrix} ] {s}_{0} ( t ) + [ \begin{matrix}n ( t ) \\ {n}^{*} ( t )\end{matrix} ] ;$$
wherein [ ]* represents conjugate operation, and a data covariance matrix of y(t) is:
$${R}_{N C} = E [ y ( t ) {y}^{H} ( t ) ] \text{?} [ \begin{matrix}R & {R}^{′} \\ {R}^{′ *} & {R}^{*}\end{matrix} ] ;$$
wherein R≙E[y(t)y^{H}(t)] is a covariance matrix of array output, R≙E[y(t)y^{H}(t)] wherein is an elliptical covariance matrix, [ ]^{T} is a transposition operation, and [ ]^{H} is a conjugate transposition operation.

4. The diagonalized spatial smoothing coherent DOA estimation method based on non-circular signals according to claim 3, wherein a specific implementation process of the step S3 is as follows:
assuming that M sensors are divided into P overlapping subarrays, each subarray has L elements, satisfying M=L+P−1, wherein P is a number of the overlapping subarrays, L is a number of the sensors in each subarray, and an index t is omitted, then zᵢ=A₁Dⁱ⁻¹s+nᵢ, wherein the noise vector of an I-th subarray is nᵢ; A₁=[a_{L}(θ₁), a_{L}(θ₂), . . . , a_{L}(θ_{K})] is a steering matrix corresponding to the first L elements of the array, s is a signal vector, Dⁱ⁻¹ is i−1 power of diagonal matrix D, D=diag[e^{-jπ sin θ}^{₁}, . . . , e^{-jπ sin θ}^{_{K}}], and a size is K×K; a cross covariance matrix R_{i,j} of the i-th subarray and a j-th subarray is expressed as:
$${R}_{i , j} = E [ {z}_{i} {z}_{j}^{H} ] = {A}_{1} {D}^{i - 1} {{R}_{S} ( {D}^{j - 1} )}^{H} {A}_{1}^{H} + {σ}_{n}^{2} {I}_{L} ;$$
wherein I_{L} is an identity matrix with a dimension L×L,
$${σ}_{n}^{2}$$
is a noise variance, E[ ] is an expected operation, and R_{S}=E[s(t)s^{H}(t)] is a signal covariance matrix; similarly, a backward cross covariance matrix R̅_{i,j} of the i-th subarray and the J-th subarray is:
$${\overline{R}}_{i , j} = {J [ E [ {z}_{i} {z}_{j}^{H} ] ]}^{*} J = J {R}_{i , j}^{*} J ,$$
wherein J is an L×L antisymmetric identity matrix;
a signal subspace matrix Γ_{S} is defined as
$${Γ}_{S} = {τ}_{1} {u}_{1} {u}_{1}^{H} ,$$
wherein τ₁ represents a largest eigenvalue of the matrix R after the eigenvalue decomposition, and a corresponding largest eigenvector u₁; letting u₁=At, then Γ_{S}=τ₁·At·t^{H}A^{H}, then obtaining:
$$A {R}_{S} {A}^{H} = {τ}_{1} {u}_{1} {u}_{1}^{H} + {σ}_{n}^{2} {\sum }_{j = 2}^{M} {u}_{i} {u}_{i}^{H} - {σ}_{n}^{2} {I}_{M} = {τ}_{1} {u}_{1} {u}_{1}^{H} - {σ}_{n}^{2} {u}_{1} {u}_{1}^{H} = ( {τ}_{1} - {σ}_{n}^{2} ) {u}_{1} {u}_{1}^{H} ;$$
therefore,
$$t = \frac{{R}_{S} {A}^{H} {u}_{1}}{{τ}_{1} - {σ}_{n}^{2}}$$
is a vector of K×1; letting μᵢ represent an i-th forward subarray and μᵢ=A₁Dⁱ⁻¹t, then a forward cross covariance matrix of the i-th subarray and the j-th subarray is:
$${Γ}_{i , j} = E [ {μ}_{i} {μ}_{j}^{H} ] [ = {A}_{1} {D}^{i - 1} t {{t}^{H} ( {D}^{j - 1} )}^{H} {A}_{1}^{H} ;$$
wherein
$$E [ {μ}_{i} {μ}_{j}^{H} ]$$
represents an (i: i+L−1, j: j+L−1) element of Γ_{S};
similarly, the backward cross covariance matrix of the i-th subarray and the j-th subarray is defined as:
$${\overline{Γ}}_{i , j} = {J ( E [ {μ}_{i} {μ}_{j}^{H} ] )}^{*} J = J {Γ}_{i , j}^{*} J ;$$
an ASS smoothing matrix R_{ASS} is obtained by using an augmented spatial smoothing (ASS) method:
$${R}_{ASS} = \frac{1}{3 {P}^{2}} {\sum }_{i = 1}^{p} {\sum }_{j = 1}^{p} [ ( {Γ}_{i , j} + {Γ}_{j , i} + {Γ}_{j , j} ) + ( {\overline{Γ}}_{i , j} + {\overline{Γ}}_{j , i} + {\overline{Γ}}_{j , j} ) ] ;$$
a same operation is performed on the matrix R* to obtain an ASS smoothing matrix
$${R}_{A S S}^{*} .$$

5. The diagonalized spatial smoothing coherent DOA estimation method based on non-circular signals according to claim 4, wherein a specific process of obtaining the noise subspace U_{N} in step S4 is as follows:
according to an extraction method of R and R*, splicing R_{ASS} and
$${R}_{A S S}^{*}$$
diagonally to obtain R_{NC-ASS}; at this time, R_{NC-ASS} is a covariance matrix after ASS smoothing:
$${R}_{N C - ASS} = [ \begin{matrix}{R}_{ASS} & 0 \\ 0 & {R}_{ASS}^{*}\end{matrix} ] ;$$
next, the eigenvalue decomposition is performed on R_{NC-ASS}:
$${R}_{NC - ASS} = {U}_{S} {Λ}_{S} {U}_{S}^{H} + {U}_{N} {Λ}_{N} {U}_{N}^{H} ;$$
wherein eigenvectors corresponding to the first K eigenvalues form a signal subspace U_{S}, and Λ_{S} is a diagonal matrix comprising the first K eigenvalues; remaining eigenvectors form the noise subspace U_{N}, and Λ_{N} is a diagonal matrix comprising remaining eigenvalues.

6. The diagonalized spatial smoothing coherent DOA estimation method based on non-circular signals according to claim 5, wherein a specific implementation process of step S5 is as follows:
an original steering vector is a(θₖ), and an expanded steering vector is:
$$P ( {θ}_{k} ) = [ \begin{matrix}a ( {θ}_{k} ) & {0}_{M \times 1} \\ {0}_{M \times 1} & {a}^{*} ( {θ}_{k} )\end{matrix} ] ;$$
based on the noise subspace U_{N} and a corresponding steering vector P(θₖ), DOA is accurately estimated by using a reduced-dimension MUSIC, and a spectral peak search function of the reduced-dimension MUSIC is:
$${f}_{RD - MUSIC} ( θ ) = \frac{1}{{e}^{H} [ {P ( θ )}^{H} {U}_{N} {U}_{N}^{H} P ( θ ) ] e} ;$$
wherein e=[1,0]^{T}, a location of a spectral peak of the spectral peak search function is an estimated value of the DOA.
